(19) United States
(12) Patent Application Publication
(10) Pub. No.: US 2025/0193903 A1
(43) Pub. Date: Jun. 12, 2025

(54) METHOD AND APPARATUS FOR MONITORING BUDGET CONTROL IN MULTI-CELL SCHEDULING WITH SINGLE DOWNLINK CONTROL INFORMATION

(71) Applicant: MEDIATEK INC., Hsinchu City (TW)

(72) Inventor: Chi-Hsuan HSIEH, Hsinchu City (TW)

(21) Appl. No.: 18/844,929

(22) PCT Filed: Sep. 13, 2023
(86) PCT No.: PCT/CN2023/118489

§ 371 Date: Sep. 6, 2024

Related U.S. Application Data
(60) Provisional application No. 63/377,734, filed on Sep. 30, 2022.

(51) Int. Cl. H04W 72/232; H04L 5/00

(52) U.S. Cl. CPC H04W 72/232; H04L 5/0092

(57) ABSTRACT

Various solutions for enhancements on monitoring budget control in multi-cell scheduling with a single downlink control information (DCI) are described. An apparatus may receive a DCI indicating a scheduling of a plurality of cells from a network node of a wireless network. The apparatus may determine a first cell among the plurality of cells according to a table indicating at least one mapping between the plurality of cells and the first cell. The apparatus may count a corresponding DCI size and a number of blind decodings (BDs) or control channel elements (CCEs) on the first cell.

### CROSS REFERENCE TO RELATED PATENT APPLICATION(S)

The present disclosure is part of a non-provisional application claiming the priority benefit of U.S. Patent Application No. 63/377,734, filed 30 Sep. 2022, the content of which herein being incorporated by reference in its entirety.

### TECHNICAL FIELD

The present disclosure is generally related to mobile communications and, more particularly, to monitoring budget control in multi-cell scheduling with a single downlink control information (DCI).

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using a plurality of cells forming a radio access network. The BS may support the operations of the plurality of cells, and each cell may be operable to provide services to at least one user equipment (UE) within its radio coverage. Specifically, each cell may provide services to serve one or more UEs within its radio coverage based on at least one downlink control information (DCI), where a radio coverage of one cell may overlap with another radio coverage of other cell(s). In one example, each cell may schedule a downlink/uplink (DL/UL) resource to one UE within its radio coverage by one DCI for performing a DL/UL transmission. If the UE can support more than one cells (e.g., in dual connectivity/carrier aggregation), the UE may receive more than one DCI for scheduling DL/UL transmissions with the more than one cells. As that, the network and the BS have to configure a plurality of DCIs corresponding to the plurality of cells respectively to the UE so as to schedule resources for the DL/UL transmissions between the UE and the cells, which may lack of transmission efficiency and waste available network resources. In addition, there is a bit number limit for decoding the DCI if one specific decoding technique (e.g., polar decoding technique) is utilized by the UE. That is, the field number/size of the DCI should comply with a bit-limit rule/regulation.

Accordingly, how to improve multi-cell scheduling with a single DCI becomes an important issue for the newly developed wireless communication network. In particular, the issues of DCI aggregation for multi-cell scheduling further involve physical downlink control channel (PDCCH) monitoring budget control, search space configuration, and reference physical downlink shared channel (PDSCH) for hybrid automatic repeat request (HARQ) feedbacks. Therefore, there is a need to provide proper schemes to solve these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to enhancements on monitoring budget control in multi-cell scheduling with a single DCI.

In one aspect, a method may involve an apparatus receiving a DCI indicating a scheduling of a plurality of cells from a network node of a wireless network. The method may also involve the apparatus determining a first cell among the plurality of cells according to a table indicating at least one mapping between the plurality of cells and the first cell. The method may further involve the apparatus counting a corresponding DCI size and a number of blind decodings (BDs) or control channel elements (CCEs) on the first cell.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a DCI indicating a scheduling of a plurality of cells from the network node. The processor may also perform operations comprising determining a first cell among the plurality of cells according to a table indicating at least one mapping between the plurality of cells and the first cell. The processor may further perform operations comprising counting a corresponding DCI size and a number of BDs or CCEs on the first cell.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of DCI reception corresponding to a plurality of cells in the current 5G NR framework.

FIG. 2 is a diagram depicting an example scenario of two types of multi-cell scheduling DCI in accordance with implementations of the present disclosure.

FIG. 3 is a diagram depicting an example scenario of a table for monitoring budget control in accordance with implementations of the present disclosure.

FIG. 4 is a diagram depicting an example scenario of multi-cell scheduling with a single DCI in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

FIG. 8 is a flowchart of another example process in accordance with an implementation of the present disclosure.

FIG. 9 is a flowchart of another example process in accordance with an implementation of the present disclosure.

FIG. 10 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on multi-cell scheduling with a single DCI. According to the present disclosure, a number of possible solutions may be implemented separately or jointly. That is, although these possible solutions may be described below separately, two or more of these possible solutions may be implemented in one combination or another.

In 3^{rd} Generation Partnership Project (3GPP), a radio access network (e.g., 5G NR access network) may include a plurality of BSs (e.g., Next Generation Node-Bs (gNBs)) to communicate with a plurality of mobile stations referred as UEs. In the current 5G NR framework, one BS is operable to provide radio coverage to a specific geographical area using a plurality of cells forming a radio access network. The BS may support the operations of the plurality of cells, and each cell may be operable to provide services to at least one UE within its radio coverage. Specifically, each cell may provide services to serve one or more UEs within its radio coverage based on at least one DCI, where a radio coverage of one cell may overlap with another radio coverage of other cell(s). In one example, each cell may schedule a DL/UL resource to one UE within its radio coverage by one DCI for performing a DL/UL transmission. If the UE can support more than one cell (e.g., application in dual connectivity), the UE may receive more than one DCI for scheduling DL/UL transmissions with the more than one cells.

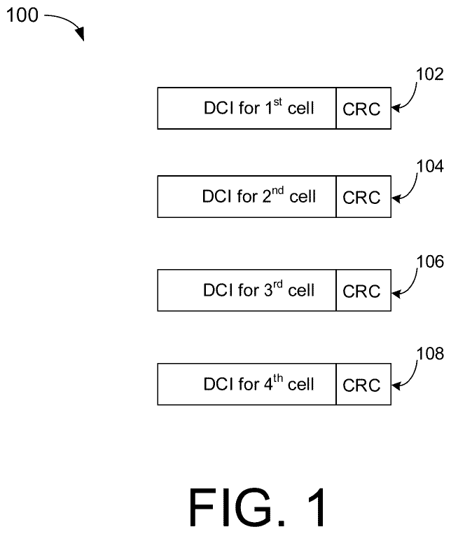

FIG. 1 illustrates an example scenario 100 of DCI reception corresponding to a plurality of cells in the current 5G NR framework. In scenario 100, at least one BS may serve the UE with four cells and provide four DCIs 102, 104, 106 and 108. Specifically, the DCI 102 is utilized for a scheduling of a 1^{st} cell with the UE, the DCI 104 is utilized for a scheduling of a 2^{nd} cell with the UE, the DCI 106 is utilized for a scheduling of a 3^{rd} cell with the UE, and the DCI 108 is utilized for a scheduling of a 4^{th} cell with the UE. In one example, each DCI is attached with a cyclic redundancy check (CRC) for error decoding, and includes at least one designated bit field (e.g., 60 bits) and one CRC field (e.g., 24 bits), where the designated bit field includes a scheduling information for one cell. As that, the UE may communicate with the four cells (e.g., 1^{st} cell, 2^{nd} cell, 3^{rd} cell and 4^{th} cell) and perform a PDSCH reception or a PUSCH transmission scheduled by the four DCIs 102, 104, 106 and 108, respectively.

Based on different transmissions and capabilities of the UE, the network and the BS may configure a plurality of DCIs corresponding to a plurality of cells to the UE so as to schedule relevant resources for the DL/UL transmissions between the UE and the cells. However, it seems less efficient if the network resource(s) may not be enough to serve all UEs within the radio coverages. In addition, there is a bit-limit (e.g., less than 140 bits) for decoding the DCI if one specific decoding technique (e.g., polar decoding technique) is utilized by the UE. As that, how to improve multi-cell scheduling with a single DCI becomes an important issue for the newly developed wireless communication network. In particular, the issues of DCI aggregation for multi-cell scheduling further involve monitoring budget control, search space configuration, and reference PDSCH for HARQ feedbacks. Therefore, there is a need to provide proper schemes to solve these issues.

In view of the above, the present disclosure proposes a number of schemes pertaining to enhancements on multi-cell scheduling with a single DCI. According to some schemes of the present disclosure, a radio resource control (RRC) configured or pre-defined table for monitoring budget control may be introduced for a multi-cell scheduling DCI, to clearly define which cell should the corresponding DCI size and the number of BDs/CCEs be counted on during the PDCCH monitoring in the UE. According to some schemes of the present disclosure, the search space(s) for a multi-cell scheduling DCI (e.g., DCI format 0_X/1_X) may be only configured on the scheduling cell. According to some schemes of the present disclosure, the reference PDSCH for HARQ feedbacks may be the last PDSCH of co-scheduled PDSCHs by a multi-cell scheduling DCI. Accordingly, by applying the schemes of the present disclosure, monitoring budget control, search space configuration, and reference PDSCH for HARQ feedbacks may be adapted properly in multi-cell scheduling with a single DCI.

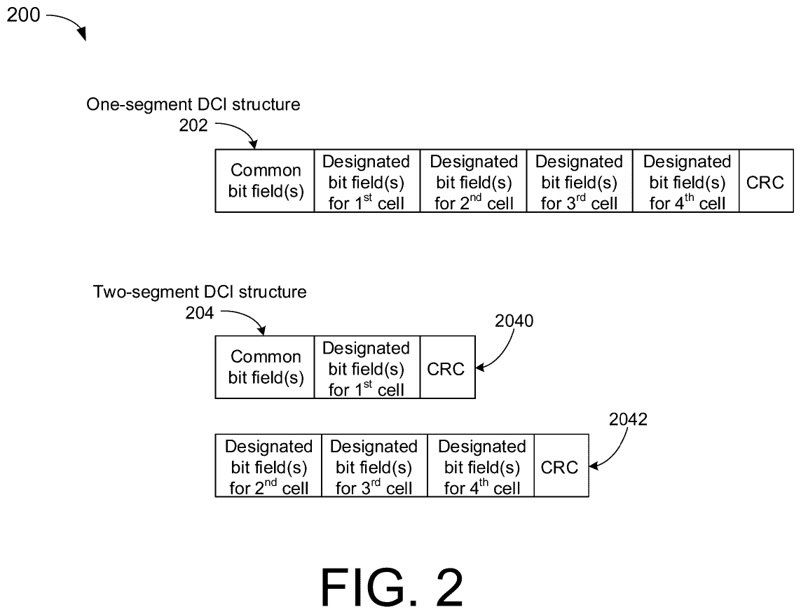

FIG. 2 illustrates an example scenario 200 of two types of multi-cell scheduling DCI in accordance with implementations of the present disclosure. As shown in FIG. 2, the implementation in scenario 200 being similar to scenario 100 may include at least one BS serving the UE with four cells (e.g., 1^{st} cell, 2^{nd} cell, 3^{rd} cell and 4^{th} cell), and the difference is that the BS in scenario 200 may configure a single DCI to the UE with the four cells (e.g., 1^{st} cell, 2^{nd} cell, 3^{rd} cell and 4^{th} cell). In one example, the UE may receive the single DCI via one cell (e.g., 15t cell), and the other cells (e.g., 2^{nd} cell, 3^{rd} cell and 4^{th} cell) are scheduled by the same single DCI received in the previous cell (e.g., 1^{st} cell). Since the UE may utilize one specific decoding technique (e.g., polar decoding technique) for decoding the single DCI, the network and/or the BS may adaptively configure a field number/size of the single DCI complying with the bit-limit rule (e.g., less than 140 bits).

In some implementations, based on the bit-limit rule, the single DCI may have two types of DCI structure, i.e., a one-segment DCI structure 202 and a two-segment DCI structure 204. In one example, the one-segment DCI structure 202 may be an aggregated DCI including a common bit field, four designated bit fields corresponding to four cells (e.g., 1^{st} cell, 2^{nd} cell, 3^{rd} cell and 4^{th} cell), and a CRC bit field. In addition, the two-segment DCI structure 204 may include two DCI segments 2040 and 2042 that can be formed by adaptively dividing the one-segment DCI structure 202 as two independent DCIs, and the UE may link both the two DCI segments 2040 and 2042 together before deciding the DCI for scheduling information. Specifically, the DCI segment 2040 may include a common bit field, a first part of designated bit fields corresponding to at least one of the four cells and the CRC bit field, and the DCI segment 2042 may include a second part of designated bit fields corresponding the other cells and the CRC bit field. In one example, the DCI segment 2040 may have one designated bit field corresponding to one cell (e.g., 1^{st} cell), and the DCI segment 2042 may have three designated bit fields corresponding to three cells (e.g., 2^{nd} cell, 3^{rd} cell and 4^{th} cell).

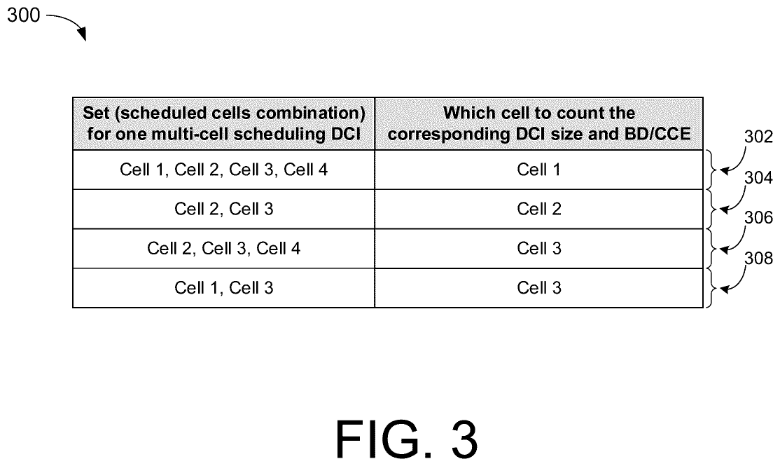

FIG. 3 illustrates an example scenario 300 of a table for monitoring budget control in accordance with implementations of the present disclosure. In scenario 300, a table for monitoring budget control is introduced for clearly defining which cell should the corresponding DCI size and the number of BDs/CCEs be counted on during the PDCCH monitoring in the UE. Specifically, the table may include multiple mappings, each indicates a respective set of scheduled cells (i.e., a scheduled cells combination) for a multi-cell scheduling DCI and which cell of the set should the corresponding DCI size and the number of BDs/CCEs be counted on. For instance, mapping 302 indicates that the scheduled cells combination includes four cells (e.g., cell 1, cell 2, cell 3, and cell 4) and the first cell (e.g., cell 1) is the cell which the corresponding DCI size and the number of BDs/CCEs should be counted on. Mapping 304 indicates that the scheduled cells combination includes two cells (e.g., cell 2 and cell 3) and the first cell (e.g., cell 2) is the cell which the corresponding DCI size and the number of BDs/CCEs should be counted on. Mapping 306 indicates that the scheduled cells combination includes three cells (e.g., cell 2, cell 3, and cell 4) and the second cell (e.g., cell 3) is the cell which the corresponding DCI size and the number of BDs/CCEs should be counted on. Mapping 308 indicates that the scheduled cells combination includes two cells (e.g., cell 1 and cell 3) and the second cell (e.g., cell 3) is the cell which the corresponding DCI size and the number of BDs/CCEs should be counted on.

In some implementations, the table may be RRC configured (e.g., received via an RRC configuration) or pre-defined (e.g., a pre-defined table stored in the UE).

In some implementations, the multi-cell scheduling DCI may correspond to a one-segment DCI structure or a two-segment DCI structure (as shown in FIG. 2).

In some implementations, the multi-cell scheduling DCI may include a DCI format 0_0 or 0_1 for scheduling of a PUSCH transmission on at least one of the plurality of cells.

In some implementations, the multi-cell scheduling DCI may include a DCI format 1_0 or 1_1 for scheduling of a PDSCH reception on at least one of the plurality of cells.

Alternatively, a pre-defined rule instead of the aforementioned table may be used to define which cell should the corresponding DCI size and the number of BDs/CCEs be counted on. For instance, the corresponding DCI size and the number of BDs/CCEs may be counted on the co-scheduled cell with the lowest ServCellIndex, or may be counted on the co-scheduled cell with the highest ServCellIndex.

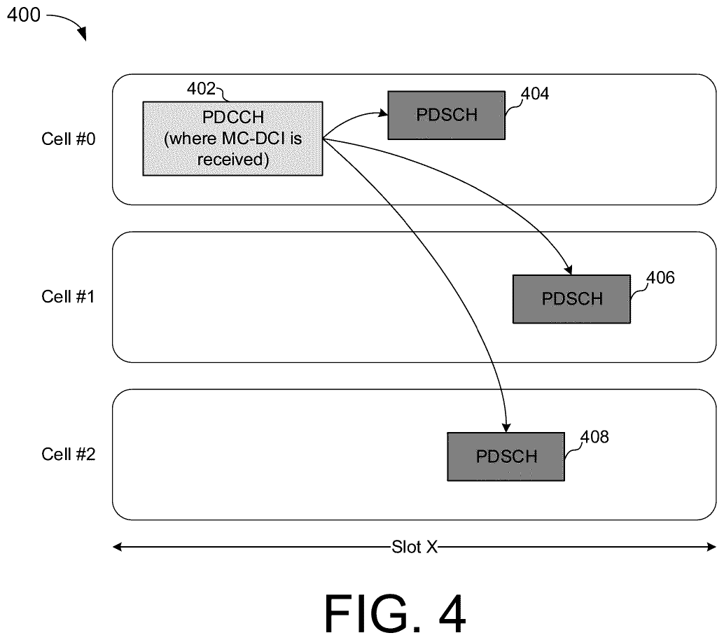

FIG. 4 illustrates an example scenario 400 of multi-cell scheduling with a single DCI in accordance with implementations of the present disclosure. In scenario 400, a multi-cell scheduling DCI 402 is received on the PDCCH of a cell with ServCellIndex=0, which is also called the scheduling cell. Specifically, the multi-cell scheduling DCI 402 is utilized for scheduling of a PDSCH reception 404 on the cell with ServCellIndex=0, a PDSCH reception 406 on the cell with ServCellIndex=1 (also called a co-scheduled cell), and a PDSCH reception 408 on the cell with ServCellIndex=2 (also called a co-scheduled cell). As that, the UE may communicate with these three cells (e.g., cell #0, cell #1, and cell #2) and perform PDSCH receptions scheduled by the multi-cell scheduling DCI 402.

In some implementations, the search space(s) for multi-cell scheduling DCI (e.g., DCI format 0_X/1_X) may only be configured on the scheduling cell. That is, the UE may receive a configuration of the search space(s) for multi-cell scheduling DCI on the scheduling cell, and receive the multi-cell scheduling DCI according to the configuration of the search space(s). Alternatively, the search space(s) for multi-cell scheduling DCI may be configured under the cell which the corresponding DCI size and the number of BDs/CCEs are counted on.

In some implementations, the reference PDSCH for HARQ feedbacks may be the last PDSCH of co-scheduled PDSCHs by multi-cell scheduling DCI, i.e., the PDSCH reception that comes in last in the time domain among the co-scheduled PDSCHs. Taking scenario 400 as an example, the reference PDSCH is the co-scheduled PDSCH 406 as it comes in last in the time domain among co-scheduled PDSCHs 404, 406, and 408. Accordingly, the UE may perform a PUCCH/PUSCH transmission including HARQ feedbacks (e.g., HARQ acknowledgement (ACK) or non-acknowledgement (NACK)) on the co-scheduled PDSCH receptions, by reference to the last PDSCH reception.

### Illustrative Implementations

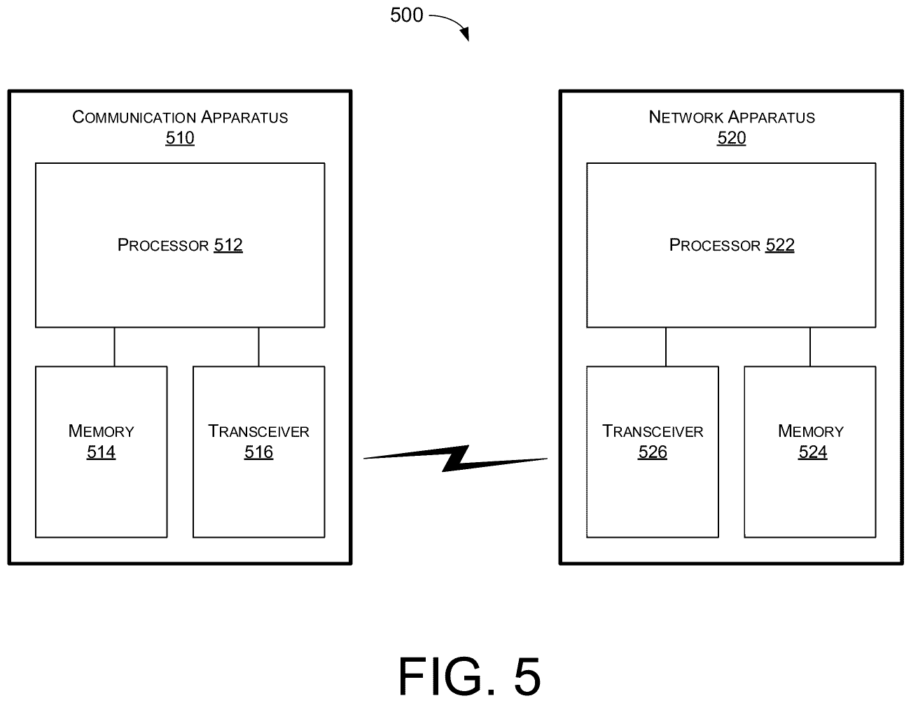

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to enhancements on multi-cell scheduling with a single DCI, including scenarios/schemes described above as well as processes 600, 700, 800, 900, and 1000 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a base station, a small cell, a router or a gateway. For instance, network apparatus 520 may be implemented in an eNodeB in an LTE, LTE-Advanced or LTE-Advanced Pro network or in a gNB in a 5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including multi-cell scheduling with a single DCI in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

According to some schemes of the present disclosure, processor 512 may receive, via transceiver 516, a DCI indicating a scheduling of a plurality of cells from network apparatus 520. Then, processor 512 may determine a first cell among the plurality of cells according to a table indicating at least one mapping between the plurality of cells and the first cell. Also, processor 512 may count a corresponding DCI size and a number of BDs/CCEs on the first cell.

In some implementations, processor 512 may receive, via transceiver 516, an RRC configuration including the table from network apparatus 520.

In some implementations, the table may be a pre-defined table stored in communication apparatus 510.

In some implementations, the table may include a plurality of mappings, and each mapping may indicate a respective set of cells for one multi-cell scheduling DCI and which cell that the corresponding DCI size and the number of BDs/CCEs are to be counted on.

In some implementations, processor 512 may monitor, via transceiver 516, a PDCCH for receiving the DCI, and the counting of the corresponding DCI size and the number of BDs or CCEs on the first cell may be performed during the PDCCH monitoring.

In some implementations, the DCI may correspond to a one-segment DCI structure or a two-segment DCI structure. The one-segment DCI structure may include a common bit field and a plurality of designated bit fields corresponding to the plurality of cells. The two-segment DCI structure may include a common bit field, a first part of a plurality of designated bit fields corresponding to the plurality of cells, and a second part of the plurality of designated bit fields.

In some implementations, the DCI may include a DCI format 0_0 or 0_1 for scheduling of a PUSCH transmission on at least one of the plurality of cells.

In some implementations, the DCI may include a DCI format 1_0 or 1_1 for scheduling of a PDSCH reception on at least one of the plurality of cells.

According to some schemes of the present disclosure, processor 512 may receive, via transceiver 516, a configuration of one or more search spaces for multi-cell scheduling DCI on a scheduling cell. Then, processor 512 may receive, via transceiver 516, a DCI indicating a scheduling of a plurality of cells on the scheduling cell according to the configuration of the one or more search spaces. Also, processor 512 may perform, via transceiver 516, a PDSCH reception or a PUSCH transmission on at least one of the plurality of cells based on the DCI. Correspondingly, processor 522 may transmit, via transceiver 526, a configuration of one or more search spaces for multi-cell scheduling DCI to communication apparatus 510 on a scheduling cell. Then, processor 522 may transmit, via transceiver 526, a DCI indicating a scheduling of a plurality of cells to communication apparatus 510 on the scheduling cell according to the configuration of the one or more search spaces. Also, processor 522 may transmit or receive, via transceiver 526, a PDSCH or a PUSCH on at least one of the plurality of cells based on the DCI.

In some implementations, the configuration of the one or more search spaces may be received only on the scheduling cell. Alternatively, the configuration of the one or more search spaces may be received/configured under the cell which the corresponding DCI size and the number of BDs/CCEs are counted on.

In some implementations, the DCI may correspond to a one-segment DCI structure or a two-segment DCI structure. The one-segment DCI structure may include a common bit field and a plurality of designated bit fields corresponding to the plurality of cells. The two-segment DCI structure may include a common bit field, a first part of a plurality of designated bit fields corresponding to the plurality of cells, and a second part of the plurality of designated bit fields.

In some implementations, the DCI may include a DCI format 0_0 or 0_1 for scheduling of the PUSCH transmission on at least one of the plurality of cells.

In some implementations, the DCI may include a DCI format 1_0 or 1_1 for scheduling of the PDSCH reception on at least one of the plurality of cells.

According to some schemes of the present disclosure, processor 512 may receive, via transceiver 516, a DCI indicating a scheduling of a plurality of cells from network apparatus 520. Then, processor 512 may determine a last PDSCH reception among a plurality of PDSCH receptions scheduled by the DCI. Also, processor 512 may perform a PUCCH/PUSCH transmission comprising feedbacks on the plurality of PDSCH receptions, by reference to the last PDSCH reception. Correspondingly, processor 522 may transmit, via transceiver 526, a DCI indicating a scheduling of a plurality of cells to communication apparatus 510. Then, processor 522 may determine a last PDSCH reception among a plurality of PDSCH receptions scheduled by the DCI. Also, processor 522 may receive, via transceiver 526, a PUCCH/PUSCH with feedbacks on the plurality of PDSCH receptions, by reference to the last PDSCH reception.

In some implementations, the last PDSCH reception may include a PDSCH reception that comes in last in a time domain among the plurality of PDSCH receptions.

In some implementations, each of the feedbacks may include a HARQ ACK or NACK for a respective one of the plurality of PDSCH receptions.

In some implementations, the DCI may correspond to a one-segment DCI structure or a two-segment DCI structure. The one-segment DCI structure may include a common bit field and a plurality of designated bit fields corresponding to the plurality of cells. The two-segment DCI structure may include a common bit field, a first part of a plurality of designated bit fields corresponding to the plurality of cells, and a second part of the plurality of designated bit fields. In some implementations, the DCI may include a DCI format 1_0 or 1_1 for scheduling of a PDSCH reception on at least one of the plurality of cells.

### Illustrative Processes

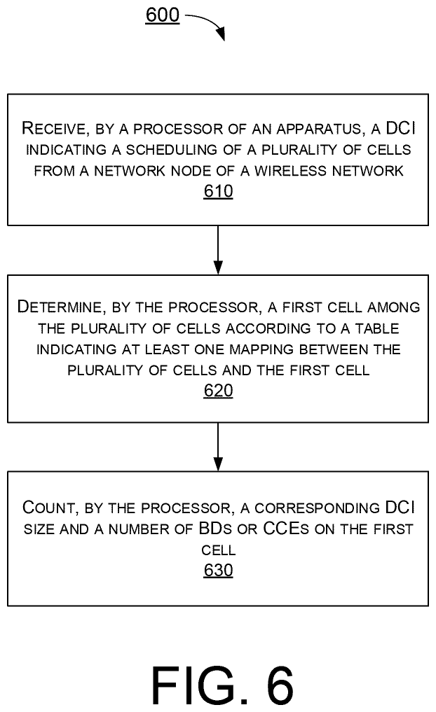

FIG. 6 illustrates an example process 600 in accordance with an implementation of the present disclosure. Process 600 may be an example implementation of above scenarios/schemes, whether partially or completely, with respect to enhancements on monitoring budget control in multi-cell scheduling with a single DCI. Process 600 may represent an aspect of implementation of features of communication apparatus 510. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At 610, process 600 may involve processor 512 of communication apparatus 510 receiving, via transceiver 516, a DCI indicating a scheduling of a plurality of cells from a network node (e.g., network apparatus 520) of a wireless network. Process 600 may proceed from 610 to 620.

At 620, process 600 may involve processor 512 determining a first cell among the plurality of cells according to a table indicating at least one mapping between the plurality of cells and the first cell. Process 600 may proceed from 620 to 630.

At 630, process 600 may involve processor 512 counting a corresponding DCI size and a number of BDs/CCEs on the first cell.

In some implementations, process 600 may further involve processor 512 receiving an RRC configuration including the table from the network node (e.g., network apparatus 320).

In some implementations, the table may be a pre-defined table stored in communication apparatus 510.

In some implementations, the table may include a plurality of mappings, and each mapping may indicate a respective set of cells for one multi-cell scheduling DCI and which cell that the corresponding DCI size and the number of BDs or CCEs are to be counted on.

In some implementations, process 600 may further involve processor 512 monitoring, via transceiver 516, a PDCCH for receiving the DCI. The counting of the corresponding DCI size and the number of BDs/CCEs on the first cell may be performed during the PDCCH monitoring.

In some implementations, the DCI may correspond to a one-segment DCI structure or a two-segment DCI structure. The one-segment DCI structure may include a common bit field and a plurality of designated bit fields corresponding to the plurality of cells. The two-segment DCI structure may include a common bit field, a first part of a plurality of designated bit fields corresponding to the plurality of cells, and a second part of the plurality of designated bit fields.

In some implementations, the DCI may include a DCI format 0_0 or 0_1 for scheduling of a PUSCH transmission on at least one of the plurality of cells.

In some implementations, the DCI may include a DCI format 1_0 or 1_1 for scheduling of a PDSCH reception on at least one of the plurality of cells.

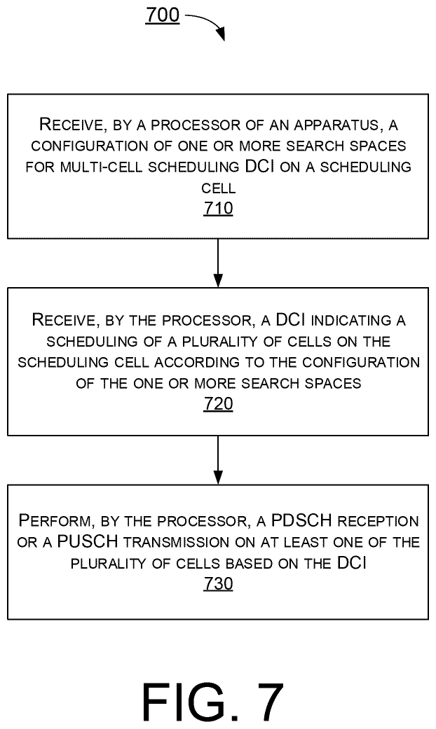

FIG. 7 illustrates an example process 700 in accordance with an implementation of the present disclosure. Process 700 may be an example implementation of above scenarios/schemes, whether partially or completely, with respect to enhancements on search space configuration for multi-cell scheduling with a single DCI. Process 700 may represent an aspect of implementation of features of network apparatus 520. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 510 or any suitable UE or machine type devices. Solely for illustrative purposes and without limitation, process 700 is described below in the context of communication apparatus 510. Process 700 may begin at block 710.

At 710, process 700 may involve processor 512 of communication apparatus 510 receiving, via transceiver 516, a configuration of one or more search spaces for multi-cell scheduling DCI on a scheduling cell. Process 700 may proceed from 710 to 720.

At 720, process 700 may involve processor 512 receiving, via transceiver 516, a DCI indicating a scheduling of a plurality of cells on the scheduling cell according to the configuration of the one or more search spaces. Process 700 may proceed from 720 to 730.

At 730, process 700 may involve processor 512 performing, via transceiver 516, a PDSCH reception or a PUSCH transmission on at least one of the plurality of cells based on the DCI.

In some implementations, the configuration of the one or more search spaces may be received only on the scheduling cell.

In some implementations, the DCI may correspond to a one-segment DCI structure or a two-segment DCI structure. The one-segment DCI structure may include a common bit field and a plurality of designated bit fields corresponding to the plurality of cells. The two-segment DCI structure may include a common bit field, a first part of a plurality of designated bit fields corresponding to the plurality of cells, and a second part of the plurality of designated bit fields.

In some implementations, the DCI may include a DCI format 0_0 or 0_1 for scheduling of the PUSCH transmission on at least one of the plurality of cells.

In some implementations, the DCI may include a DCI format 1_0 or 1_1 for scheduling of the PDSCH reception on at least one of the plurality of cells.

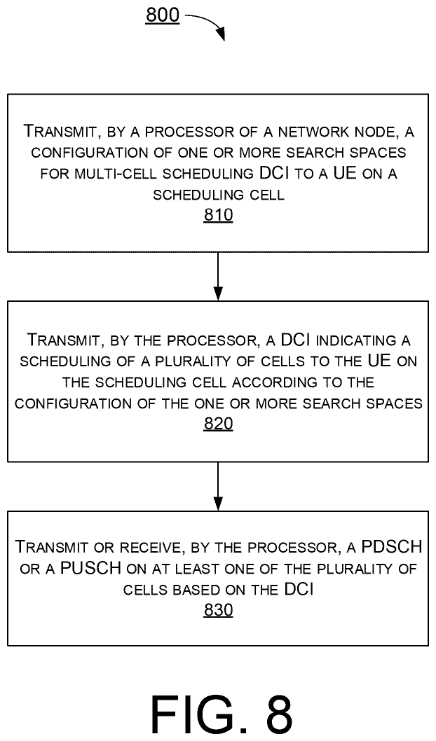

FIG. 8 illustrates an example process 800 in accordance with an implementation of the present disclosure. Process 800 may be an example implementation of above scenarios/schemes, whether partially or completely, with respect to enhancements on search space configuration for multi-cell scheduling with a single DCI. Process 800 may represent an aspect of implementation of features of network apparatus 520. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 520 or any suitable BS or network nodes. Solely for illustrative purposes and without limitation, process 800 is described below in the context of network apparatus 520. Process 800 may begin at block 810.

At 810, process 800 may involve processor 522 of network apparatus 520 transmitting, via transceiver 526, a configuration of one or more search spaces for multi-cell scheduling DCI to a UE (e.g., communication apparatus 510) on a scheduling cell. Process 800 may proceed from 810 to 820.

At 820, process 800 may involve processor 522 transmitting, via transceiver 526, a DCI indicating a scheduling of a plurality of cells to the UE on the scheduling cell according to the configuration of the one or more search spaces. The DCI may be transmitted to the UE to schedule a PDSCH reception or a PUSCH transmission on at least one of the plurality of cells. Process 800 may proceed from 820 to 830.

At 830, process 800 may involve processor 522 transmitting a PDSCH or receiving a PUSCH on at least one of the plurality of cells based on the DCI.

In some implementations, the configuration of the one or more search space may be transmitted only on the scheduling cell.

In some implementations, the DCI may correspond to a one-segment DCI structure or a two-segment DCI structure. The one-segment DCI structure may include a common bit field and a plurality of designated bit fields corresponding to the plurality of cells. The two-segment DCI structure may include a common bit field, a first part of a plurality of designated bit fields corresponding to the plurality of cells, and a second part of the plurality of designated bit fields.

In some implementations, the DCI may include a DCI format 0_0 or 0_1 for scheduling of the PUSCH transmission on at least one of the plurality of cells, or a DCI format 1_0 or 1_1 for scheduling of the PDSCH reception on at least one of the plurality of cells.

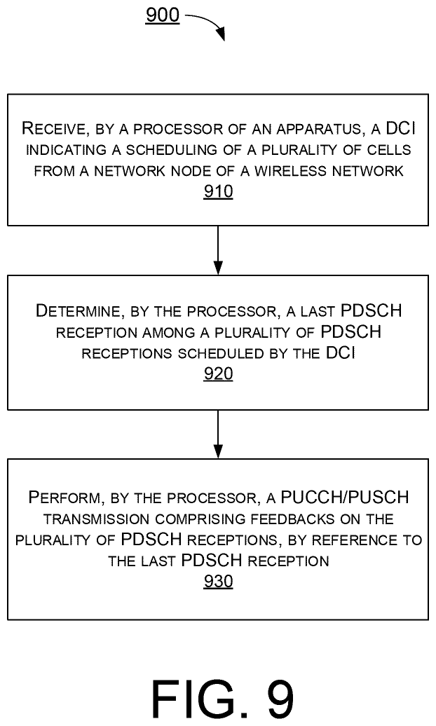

FIG. 9 illustrates an example process 900 in accordance with an implementation of the present disclosure. Process 900 may be an example implementation of above scenarios/schemes, whether partially or completely, with respect to enhancements on reference PDSCH for HARQ feedbacks in multi-cell scheduling with a single DCI. Process 900 may represent an aspect of implementation of features of network apparatus 520. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 510 or any suitable UE or machine type devices. Solely for illustrative purposes and without limitation, process 900 is described below in the context of communication apparatus 510. Process 900 may begin at block 910.

At 910, process 900 may involve processor 512 of communication apparatus 510 receiving, via transceiver 516, a DCI indicating a scheduling of a plurality of cells from a network node (e.g., network apparatus 520) of a wireless network. Process 900 may proceed from 910 to 920.

At 920, process 900 may involve processor 512 determining a last PDSCH reception among a plurality of PDSCH receptions scheduled by the DCI. Process 900 may proceed from 920 to 930.

At 930, process 900 may involve processor 512 performing, via transceiver 516, a PUCCH/PUSCH transmission comprising feedbacks on the plurality of PDSCH receptions, by reference to the last PDSCH reception.

In some implementations, the last PDSCH reception may include a PDSCH reception that comes in last in a time domain among the plurality of PDSCH receptions.

In some implementations, each of the feedbacks may include a HARQ ACK or NACK for a respective one of the plurality of PDSCH receptions.

In some implementations, the DCI may correspond to a one-segment DCI structure or a two-segment DCI structure. The one-segment DCI structure may include a common bit field and a plurality of designated bit fields corresponding to the plurality of cells. The two-segment DCI structure may include a common bit field, a first part of a plurality of designated bit fields corresponding to the plurality of cells, and a second part of the plurality of designated bit fields.

In some implementations, the DCI may include a DCI format 1_0 or 1_1 for scheduling of a PDSCH reception on at least one of the plurality of cells.

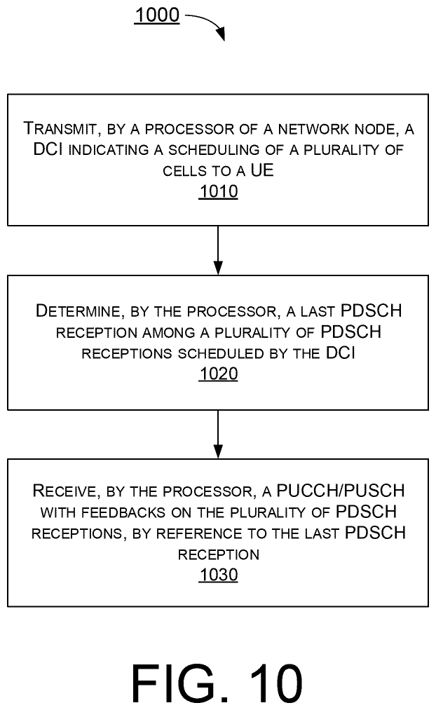

FIG. 10 illustrates an example process 1000 in accordance with an implementation of the present disclosure. Process 1000 may be an example implementation of above scenarios/schemes, whether partially or completely, with respect to enhancements on reference PDSCH for HARQ feedbacks in multi-cell scheduling with a single DCI. Process 1000 may represent an aspect of implementation of features of network apparatus 520. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 520 or any suitable BS or network nodes. Solely for illustrative purposes and without limitation, process 1000 is described below in the context of network apparatus 520. Process 1000 may begin at block 1010.

At 1010, process 1000 may involve processor 522 of network apparatus 520 transmitting, via transceiver 526, a DCI indicating a scheduling of a plurality of cells to a UE (e.g., communication apparatus 510). Process 1000 may proceed from 1010 to 1020.

At 1020, process 1000 may involve processor 522 determining a last PDSCH reception among a plurality of PDSCH receptions scheduled by the DCI. Process 1000 may proceed from 1020 to 1030.

At 1030, process 1000 may involve processor 522 receiving, via transceiver 526, a PUCCH/PUSCH with feedbacks on the plurality of PDSCH receptions, by reference to the last PDSCH reception.

In some implementations, the last PDSCH reception may include a PDSCH reception that comes in last in a time domain among the plurality of PDSCH receptions.

In some implementations, each of the feedbacks may include a HARQ ACK or NACK for a respective one of the plurality of PDSCH receptions.

In some implementations, the DCI may correspond to a one-segment DCI structure or a two-segment DCI structure. The one-segment DCI structure may include a common bit field and a plurality of designated bit fields corresponding to the plurality of cells. The two-segment DCI structure may include a common bit field, a first part of a plurality of designated bit fields corresponding to the plurality of cells, and a second part of the plurality of designated bit fields.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI) indicating a scheduling of a plurality of cells from a network node of a wireless network;
determining, by the processor, a first cell among the plurality of cells according to a table indicating at least one mapping between the plurality of cells and the first cell; and
counting, by the processor, a corresponding DCI size and a number of blind decodings (BDs) or control channel elements (CCEs) on the first cell.

2. The method of claim 1, further comprising:
receiving, by the processor, a radio resource control (RRC) configuration comprising the table from the network node.

3. The method of claim 1, wherein the table is a pre-defined table stored in the apparatus.

4. The method of claim 1, wherein the table comprises a plurality of mappings, and each mapping indicates a respective set of cells for one multi-cell scheduling DCI and which cell that the corresponding DCI size and the number of BDs or CCEs are to be counted on.

5. The method of claim 1, further comprising:
monitoring, by the processor, a physical downlink control channel (PDCCH) for receiving the DCI;
wherein the counting of the corresponding DCI size and the number of BDs or CCEs on the first cell is performed during the PDCCH monitoring.

6. The method of claim 1, wherein the DCI corresponds to a one-segment DCI structure or a two-segment DCI structure.

7. The method of claim 6, wherein the one-segment DCI structure comprises a common bit field and a plurality of designated bit fields corresponding to the plurality of cells.

8. The method of claim 6, wherein the two-segment DCI structure comprises a common bit field, a first part of a plurality of designated bit fields corresponding to the plurality of cells, and a second part of the plurality of designated bit fields.

9. The method of claim 1, wherein the DCI comprises a DCI format 0_0 or 0_1 for scheduling of a physical uplink shared channel (PUSCH) transmission on at least one of the plurality of cells.

10. The method of claim 1, wherein the DCI comprises a DCI format 1_0 or 1_1 for scheduling of a physical downlink shared channel (PDSCH) reception on at least one of the plurality of cells.

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a downlink control information (DCI) indicating a scheduling of a plurality of cells from the network node;
determining a first cell among the plurality of cells according to a table indicating at least one mapping between the plurality of cells and the first cell; and
counting a corresponding DCI size and a number of blind decodings (BDs) or control channel elements (CCEs) on the first cell.

12. The apparatus of claim 11, wherein, during operation, the processor further performs operations comprising:
receiving, via the transceiver, a radio resource control (RRC) configuration comprising the table from the network node.

13. The apparatus of claim 11, wherein the table is a pre-defined table stored in the apparatus.

14. The apparatus of claim 11, wherein the table comprises a plurality of mappings, and each mapping indicates a respective set of cells for one multi-cell scheduling DCI and which cell that the corresponding DCI size and the number of BDs or CCEs are to be counted on.

15. The apparatus of claim 11, wherein, during operation, the processor further performs operations comprising:
monitoring, via the transceiver, a physical downlink control channel (PDCCH) for receiving the DCI;
wherein the counting of the corresponding DCI size and the number of BDs or CCEs on the first cell is performed during the PDCCH monitoring.

16. The apparatus of claim 11, wherein the DCI corresponds to a one-segment DCI structure or a two-segment DCI structure.

17. The apparatus of claim 16, wherein the one-segment DCI structure comprises a common bit field and a plurality of designated bit fields corresponding to the plurality of cells.

18. The apparatus of claim 16, wherein the two-segment DCI structure comprises a common bit field, a first part of a plurality of designated bit fields corresponding to the plurality of cells, and a second part of the plurality of designated bit fields.

19. The apparatus of claim 11, wherein the DCI comprises a DCI format 0_0 or 0_1 for scheduling of a physical uplink shared channel (PUSCH) transmission on at least one of the plurality of cells.

20. The apparatus of claim 11, wherein the DCI comprises a DCI format 1_0 or 1_1 for scheduling of a physical downlink shared channel (PDSCH) reception on at least one of the plurality of cells.
